(19) United States
(12) Patent Application Publication
(10) Pub. No.: US 2007/0240768 A1
(43) Pub. Date: Oct. 18, 2007

(54) LIFTING PIPE FOR PUMP TYPE LIQUID CONTAINER

(75) Inventors: Yoshihiro Odaira, Tsubame-shi (JP); Toru Goto, Tsubame-shi (JP)

Correspondence Address: DARBY & DARBY P.C., P.O. BOX 770, Church Street Station, New York, NY, 10008-0770, US

(73) Assignees: Thermos Limited Liability Company, Rolling Meadows, IL (US); Thermos K.K., Tsubame-shi (JP)

(21) Appl. No.: 11/668,902

(22) Filed: Jan. 30, 2007

(30) Foreign Application Priority Data
Jan. 31, 2006 (JP) 2006-023881

(51) Int. Cl. F16K 17/36

(52) U.S. Cl. 137/456

(57) ABSTRACT

A lifting pipe for a pump-type liquid container includes a draw-up pipe for drawing a liquid within a liquid container main body; a pouring pipe for communicating between the draw-up pipe and an exterior; and a safety valve mechanism for stanching the liquid when the liquid container main body is overturned. The safety valve mechanism comprises a case main body and a valve retainer having a safety valve. The case main body is decomposable and communicates between the draw-up pipe and the pouring pipe. The valve retainer is removably fitted within the case main body.

The present application claims priority under 35 U.S.C. §119 to Japanese Patent Application No. 2006-023881 filed on Jan. 31, 2006. The content of the application is incorporated herein by reference in its entirety.

### BACKGROUND OF THE INVENTION

1. Field of the Invention

The present invention relates to a lifting pipe, and more particularly to a lifting pipe for a pump-type liquid container which introduces pressure to pour a liquid in a liquid container to an exterior.

2. Description of the Related Art

A conventional liquid pouring passage, for example, disclosed in Japanese Utility Model publication No. 5-80435, is applied to a pump-type liquid container allowing an air pump to pour out a liquid contained in an inner bottle of a liquid container main body, and comprises a water shutoff device to stop the contained liquid flowing out from the inner bottle when the liquid container is upset or overturned. According to the literature, in order to feed the liquid into the inner bottle or discharge the residual liquid within the inner bottle, opening the lid is merely required but removal of the liquid pouring passage is not required. It also offers a benefit for facilitating cleaning of the water shutoff device.

For the above water shutoff device, however, it is difficult to provide sufficient cleaning, since the device is configured so that it can be cleaned by removing the liquid draw-up pipe out of the liquid container main body and then flowing the rinse water through the liquid draw-up pipe.

To solve such a problem, an inside stopper for an air-pot, disclosed in Japanese Patent No. 3675765, comprises a safety valve mechanism for preventing the liquid from leaking out at the overturn of the air-pot, which is configured so as to be decomposable. According to the literature, there is offered a beneficial effect that not only the safety valve mechanism but also inner parts thereof can be washed by decomposing the safety valve mechanism.

According to the literature, the liquid can be supplied into the inner bottle through the introduction port of the inner stopper lid and the vent hole of the valve retainer by merely opening the lid of the air-pot, without removing the inner stopper. The prior art, however, leaves a problem that handling, such as for feeding liquids, is difficult since both the introduction port and the vent hole are extremely smaller than the opening of the air-pot. In addition, the safety valve cover having the radial rib is configured to be directly connected to the lifting pipe, thereby causing difficulty in washing its components thoroughly.

### SUMMARY OF THE INVENTION

Therefore, in view of the above described problems, an object of the present invention is to provide a pump-type lifting pipe capable of not only improving the handling for feeding a liquid into a liquid container but also enhancing the easier and better cleaning of the lifting pipe.

In order to accomplish the object of the present invention, according to a first aspect of the present invention, there is provided a lifting pipe for a pump-type liquid container comprising: a draw-up pipe for drawing a liquid within a liquid container main body; a pouring pipe for communicating between the draw-up pipe and an exterior; and a safety valve mechanism for stanching the liquid when the liquid container main body is overturned, the safety valve mechanism comprising a case main body and a valve retainer having a safety valve, said case main body being decomposable and communicating between the draw-up pipe and the pouring pipe, and said valve retainer being removably fitted within the case main body. Thus, cleaning of the lifting pipe can be facilitated in the component level thereof.

According to a second aspect of the present invention, there is provided a lifting pipe wherein the safety valve mechanism lies below a mouth portion of the liquid container main body and at least a part of the case main body is placed at a location external to an inner wall of the mouth portion. Therefore, the mouth portion can have a wider area and there can be effectively improved the handling for filling the liquid into the liquid container and for discharging the residual liquid in the container.

According to a third aspect of the present invention, there is provided a lifting pipe wherein the safety valve mechanism comprises a wrong assembly proofing structure for preventing the safety valve and the valve retainer from being wrongly assembled to each other. In response to this, the user can reinstall the safety valve mechanism and, in other words, there can be reliably prevented the conventional problem that after the cleaning of the safety valve mechanism, it may be reinstalled with the wrongly assembled valve retainer and safety valve. Accordingly, the correctly-assembled liquid container can be used at all times.

### BRIEF DESCRIPTION OF THE DRAWINGS

The foregoing and other objects of the invention will be more clearly understood from the following description of preferred embodiments when read in conjunction with the accompanying drawings of which:

FIG. 1 is a longitudinal sectional view generally illustrating the structure of a liquid container comprising a lifting pipe according to the present invention;

FIG. 2 is a longitudinal sectional view illustrating the structure of the lifting pipe;

FIGS. 3A and 3B are exploded perspective views illustrating the structure of a safety valve and a valve retainer;

FIG. 4 is a longitudinal sectional view illustrating the arrangement of the liquid container with its lid opened;

FIG. 5A is a longitudinal sectional view illustrating the structure of a wrong assembly proofing structure in a case that the valve retainer is assembled upside down;

FIG. 5B is a longitudinal sectional view illustrating the structure of a wrong assembly proofing structure in a case that the safety valve has been assembled upside down; and

FIG. 5C is a longitudinal sectional view illustrating the structure of a wrong assembly proofing structure in a case that an user has made a mistake as to the order of assembling steps, i.e. the safety valve has been assembled before assembling the valve retainer.

### DESCRIPTION OF PREFERRED EMBODIMENT

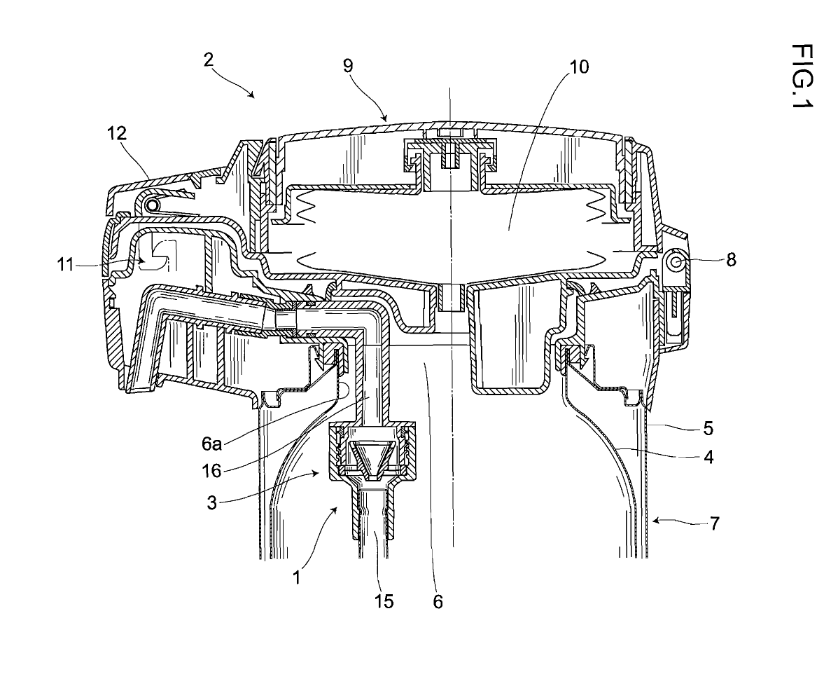

Referring to FIG. 1, a lifting pipe 1 for a pump-type liquid container is removably attached to a pump-type liquid container 2, and pours a liquid contained in the liquid container 2 to an exterior. The liquid container 2 also includes a safety valve mechanism 3 for preventing the liquid within the liquid container 2 from being leaked out when the liquid container 2 is overturned.

The liquid container 2 comprises a liquid container main body 7 and a lid 9. In the liquid container main body 7, a mouth portion 6 is formed by bonding, for example welding, tapered opening ends of stainless inner and outer bottles 4 and 5, and a vacuum layer evacuated between the inner bottle 4 and the outer bottle 5 is formed. The lid 9 opens and closes the mouth portion 6 by a hinge 8. The lid 9 comprises a pump 10 for introducing pressure into the inner bottle 4.

The liquid container 2 utilizes the pressure introduced from the pump 10 into the inner bottle 4 to pour the liquid into the exterior through the lifting pipe 1. The lid 9 comprises an engaging mechanism 11, which is configured so that when a pressing member 12 is pressed, engagement is released to open the lid 9 backward around the hinge 8, thereby opening the mouth portion 6.

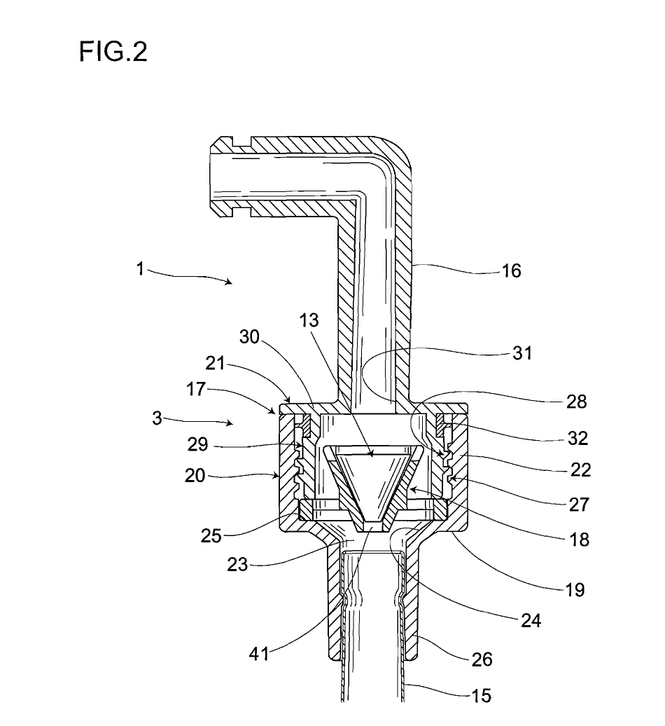

Referring to FIG. 2, when viewed as a whole, the lifting pipe 1 has an aduncate shape and it is provided on front of the mouth portion 6 of the liquid container main body 7. The lifting pipe 1 includes a draw-up pipe 15 for drawing the liquid in the inner bottle 4, a pouring pipe 16 for communicating between the draw-up pipe 15 and the exterior, and a safety valve mechanism 3 for shutting off the water at the rollover i.e. overturn of the liquid container 2.

The safety valve mechanism 3 comprises a decomposable case main body 17 for communicating between the draw-up pipe 15 and the pouring pipe 16 and a valve retainer 18 including a safety valve 13. The safety valve mechanism 3 is disposed in space within the liquid container main body 7, said space being created by tapering off the mouth portion 6.

The case main body 17 comprises a case 20 including a bottom portion 19 connected to the draw-up pipe 15, and a cover 21 connected to the pouring pipe 16. The case 20 and the cover 21 are threadably screwed to be decomposably integrated.

In addition to the bottom portion 19 having a disk shape, the case 20 comprises a cylindrical trunk portion 22 integrally provided with the bottom portion 19. The bottom portion 19 of the case 20 forms a through-hole 23 in the center thereof and comprises a tapered surface 24 shaped into a mortar (i.e. conically inclined toward the through-hole 23) and a bearing surface 25 disposed around the periphery of the tapered surface 24. From the through-hole 23 formed in the bottom portion 19, a connecting pipe 26 for connecting the draw-up pipe 15 is protruded vertically downward. An internal thread 27 is formed on the trunk portion 22.

The cover 21 has a disk-shaped cover portion 30 for sealing an upper opening of the case 20 and a cylindrical connection 29 forming an external thread 28 for screwing into the case 20. In a center of the cover portion 30, an opening 31 is formed so as to provide the aduncate draw-up pipe 16. The cylindrical connection 29 is shaped so as to support the valve retainer 18 by sandwiching it between a distal edge of the connection 29 and the bottom portion 19 of the case 20 when the case 20 and the cover 21 are integrated. The cover portion 30 is sized so as to seal the upper opening of the case 20. On the contrary, in a proximal edge of the connection 29, a gasket 32 is disposed for securing a sealing with the case 20. The pouring pipe 16 is formed so as to dispose the safety valve mechanism 3 in a dead space within the liquid container main body 7. In the present embodiment, the safety valve mechanism 3 is formed so that the mechanism 3 lies below the mouth portion 6 of the liquid container main body 7 and at least a part of the case main body 17 is placed at a location external to the inner wall 6a of the mouth portion 6. A pouring pipe 16 is configured so as to extend vertically upward from the center of the cover portion 30 and to be bent at a right angle.

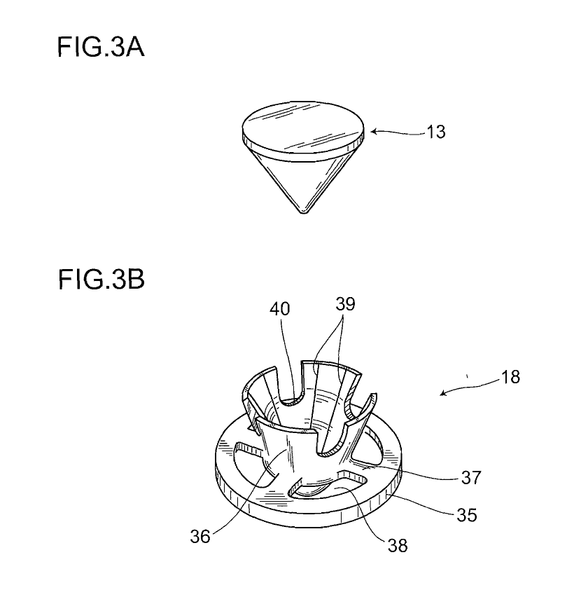

As shown in FIG. 3, the valve retainer 18 is disposed in the bottom portion 19 of the case 20 and sandwiched between the connection 29 of the cover 21 screwed into the case 20 and the bearing surface 25 of the case 20, thereby being formed to support the conical safety valve 13 in the case main body 17. The valve retainer 18 comprises a ring support portion 35, a receiving portion 36 for holding the safety valve 13, and radial connecting rods 37 for connecting the support portion 35 to the receiving portion 36. The support portion 35 has a rectangular vertical cross-section. The support portion 35 is integrated with the receiving portion 36 by a plurality of the connecting rods 37 (four rods in the figure) extending toward a central axis from the support portion 35, so as to provide liquid through-holes 38, through which the liquid is delivered, between the support portions 35 and the receiving portion 36. The receiving portion 36 is shaped into a mortar so as to hold the safety valve 13 that is conically shaped, and to provide a plurality of ribs 39 extending axially inward. At an upper end of the receiving portion 36, a through-groove 40 is provided. The through-groove 40 may be a concave groove curved away from the upper end of the receiving portion 36.

The draw-up pipe 15 is arranged concentrically with the pouring pipe 16. In practice, the through-hole 23 of the case 20 is arranged concentrically with the opening 31 of the cover 21. A bleeding hole 41 is provided in the center of the receiving portion 36.

Now, the operation and effects of the above configuration is described hereinafter.

When the pump 10 introduces a pressure into the inner bottle 4, the lifting pipe 1 disposed in the liquid container main body 7 siphons off the liquid through the draw-up pipe 15. The liquid passes through the safety valve mechanism 3 and is discharged to the exterior through the pouring pipe 16. The safety valve 13 in the safety valve mechanism 3 is supported in the valve retainer 18 merely under its own weight, and therefore, the liquid can pass through the opening 31 of the cover 21. As described above, the safety valve mechanism 3 comprises the tapered surface 24 on the bottom portion 19 of the case 20, and the through-hole 38 and the bleeding hole 41 are provided in the valve retainer 18 and the receiving portion 36, respectively. Accordingly, the accumulation of the liquid can be prevented, and thus the adhesion of the dirt can be reduced.

In the valve retainer 18, the support portion 35 is coupled to the receiving portion 36 via a plurality of the connecting rods 37 to provide the liquid through-hole 38. Accordingly the flow passage, through which the liquid is drawn up from the draw-up pipe 15, is not blocked off and the liquid can smoothly pass through the safety valve mechanism 3.

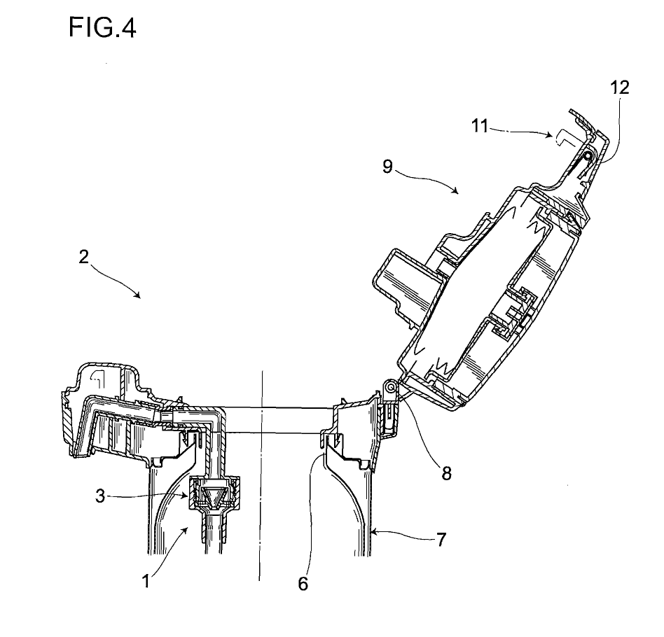

The provision of the liquid through-hole 38 resulting from the connection of the connecting rods 37 between the support portion 35 and the receiving portion 36 can lead to a miniaturization of the safety valve mechanism 3. Accordingly, as shown in FIG. 4, the safety valve mechanism 3 can lie below the mouth portion 6 of the liquid container main body 7 so as to place at least a part of the case main body 17 at a location external to the inner wall 6a of the mouth portion 6, resulting in the effective utilization of the dead space. Therefore, a wider mouth portion 6 is provided and handling for filling the liquid into the liquid container 2 and for discharging the residual liquid in the container 2 are effectively improved.

The concentric arrangement of the draw-up pipe 15 and the pouring pipe 16 can reduce not only the number of components but also manufacturing cost, and also drastically improve handling for cleaning and assembling the lifting pipe 1.

The curved through-groove 40 is provided at the upper end of the receiving portion 36, for increasing the clearance between the receiving portion 36 and an inner side of the connection 29 of the cover 21 to flow the liquid smoothly through the safety valve mechanism 3.

When the liquid container 2 is overturned, the safety valve 13 is disengaged from the valve retainer 18 and then obstructs the opening 31 of the cover 21 due to its own weight, thereby preventing the liquid from leaking out.

The installation of a plurality of the ribs 39 on the valve retainer 18 leads to reduction of the contact area of the safety valve 13 to the valve retainer 18, thereby preventing the safety valve 13 from adhering tightly to the valve retainer 18 to secure the disengagement of the safety valve 13 from the valve retainer 18. Consequently, when the liquid container 2 is overturned, the liquid can be securely prevented from leaking out.

When the overturned liquid container 2 is put back in its normal position, the liquid may not be kept in the valve retainer 18 due to the existence of the bleeding hole 41 therein. Therefore, the safety valve 13 can be smoothly returned in place within the valve retainer 18, while keeping its original posture.

The valve retainer 18 comprising a through-groove 40 at the upper end thereof, secures sufficient overall height of the valve retainer 18 so as to reliably restore the disengaged safety valve 13 to its original posture.

Next, an explanation is provided as to a procedure for cleaning the lifting pipe 1. To do this, the lifting pipe 1 is removed from the liquid container main body 7 to disassemble the safety valve mechanism 3. For the disassembly of the safety valve mechanism 3, the case 20 and the cover 21, which are screwed to each other, are released to remove the safety valve 13 and the valve retainer 18, respectively. As described above, the cleaning of the lifting pipe 3 is facilitated by disassembling the safety valve mechanism 3. The valve retainer 18 is separable from the case 20 so as to facilitate cleaning of the safety valve mechanism 3 in the component level thereof.

In order to feed a liquid into the liquid container 2 incorporating the lifting pipe 1, as shown in FIG. 4, pushing the pressing member 12 to release the engagement of the engaging mechanism 11 and pivoting the lid 9 rearwards to open the mouth portion 6 are merely required, but removal of the lifting pipe 1 is not necessary. The safety valve mechanism 3 is formed so that the mechanism 3 lies below the mouth portion 6 of the liquid container main body 7 and at least a part of the case main body 17 is placed at a location external to the inner wall 6a of the mouth portion 6. Therefore, the mouth portion 6 can be drastically widened when compared to the conventional mouth portion, in the center of which the safety valve mechanism 3 is installed. Accordingly, feeding of the liquid is easily achieved.

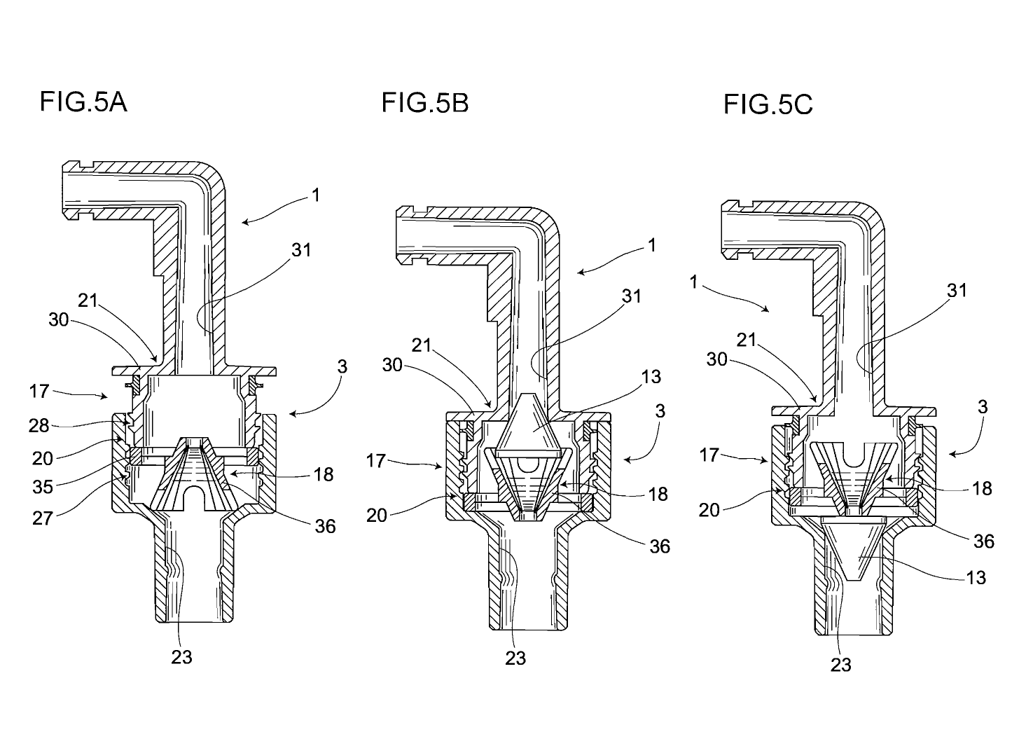

Now, an overview for a wrong assembly proofing structure incorporated in the safety valve mechanism 3 is described referring to FIGS. 5A-5C. The wrong assembly proofing structure raises the user's awareness as to the safety valve mechanism 3 which has been the wrongly assembled, by making him/her unable to assemble the safety valve mechanism 3 or clogging either the pouring pipe 16 or the draw-up pipe 15 to prevent the liquid from being discharged, even if he/she has wrongly put the valve retainer 18 and the safety valve 13 together.

Referring to FIG. 5A, an explanation is given in a case that the valve retainer 18 is assembled upside down. In this case, it is formed so that the upper end of the receiving portion 36 has a profile larger than that of the through-hole 23 and height from the upper end of the receiving portion 36 to the support portion 35 is substantially as long as that of the top of the internal thread 27 of the case 20. The upside-down assembly of the valve retainer 18 into the case 20 makes the upper end of the receiving portion 36 abut on the tapered surface 24. It may be impossible to screw the external thread 28 of the connection 29 into the internal thread 27 of the trunk portion 22 since the connection 29 may interfere with the support portion 35 of the valve retainer 18. As a result, the user may be aware that the device has been wrongly assembled.

Next, referring to FIG. 5B, there will be described a case that the safety valve 13 has been assembled upside down. If the safety valve 13 is assembled upside down into the valve retainer 18, which has been correctly oriented into the case 20, the safety valve 13 is supported above the mortar-shaped receiving portion 36. Assembling the cover 21 into the case 20 having the valve 13 oriented in this way causes the safety valve 13 to clog the opening 31. Thus, even if the lifting pipe 1 is installed in the liquid container main body 7 and then it is used to serve for pouring a liquid, the opening 31 in the lifting pipe 1 has been clogged by the safety valve 13 and thus the user is not allowed to discharge the liquid. As a result, the user may be aware that the device has been wrongly assembled.

Then, referring to FIG. 5C, there will be explained a case that the user has made a mistake as to the order of assembling steps. For example, the safety valve 13 has been inserted into the case 20 before the installation of the valve retainer 18. After this, the installation of the valve retainer 18 causes the safety valve 13 to be supported by the through-hole 23. Then, installing the cover 21 onto such a wrongly assembled case 20 makes the safety valve 13 fixed, keeping the through-hole 23 clogged. Accordingly, even if the lifting pipe 1 is installed in the liquid container main body 7 and then it is used to serve for pouring a liquid, the through-hole 23 in the lifting pipe 1 has been clogged by the safety valve 13 and thus the user is not allowed to discharge the liquid. As a result, the user may be aware that the device has been wrongly assembled.

As described above, in the cases of the wrong assembly for the valve retainer 18 and the safety valve 13, the wrong assembly proofing structure is operated so as to raise the user's awareness as to the wrong assembly. In response to this, the user can reinstall the safety valve mechanism 3 and, in other words, there can be reliably prevented the conventional problem that after the cleaning of the safety valve mechanism 3, it may be reinstalled with the wrongly-assembled valve retainer 18 and safety valve 13. Accordingly, in the present invention, the correctly-assembled liquid container 2 can be used at all times and even if the wrongly-assembled liquid container 2 is used and overturned, unexpected liquid discharge can be prevented from happening.

In the cases that the safety valve 13 has been assembled upside down (FIG. 5B) and the user has made a mistake as to the order of the steps for assembling the safety valve 13 and the valve retainer 18 (FIG. 5C), the user might be unaware that those parts have been wrongly assembled, if he/she does not try to pour out the liquid from the liquid container 2. Either the through-hole 23 or the opening 31, however, has been clogged by the safety valve 13, and therefore even if the wrongly-assembled liquid container 2 is overturned, unexpected liquid discharge can be reliably prevented.

The number of parts to be assembled in the case main body 17 is so small, i.e. only two (the safety valve 13 and the valve retainer 18), that the user is able to assemble the parts easily in the right order known from his/her experiences.

As described above, in the present embodiment, the safety valve mechanism 3 comprises: the decomposable case main body 17 in communication between the draw-up pipe 15 and the pouring pipe 16; and the valve retainer 18 including the safety valve 13, which can be detachably disposed within the case main body 17. Therefore, the safety valve mechanism 3 can be downsized so that the mouth portion 6 of the liquid container 2 can be widened and handling, such as for filling the liquid into the liquid container 2 is improved. Allowing the case main body 17 to be decomposable and the valve retainer 18 to be detachably attached to the case main body 17 facilitates cleaning of the safety valve mechanism 3 in the component level thereof.

The safety valve mechanism 3 is formed so that the mechanism 3 lies below the mouth portion 6 of the liquid container main body 7 and at least a part of the case main body 17 is placed at a location external to the inner wall 6a of the mouth portion 6. Therefore, in order to feed a liquid into the liquid container 2 or discharge the residual liquid in the container 2, opening the lid 9 is merely required but removal of the lifting pipe 1 is not necessary. Thus, the handling for the purposes is improved.

The safety valve mechanism 3 comprises the wrong assembly proofing structure for preventing the safety valve 13 and the valve retainer 18 from being wrongly assembled, so as to raise the user's awareness as to the wrong assembly. In response to this, the user can reinstall the safety valve mechanism 3 and, in other words, there can be reliably prevented the conventional problem that after the cleaning of the safety valve mechanism 3, it may be reinstalled with the wrongly-assembled valve retainer 18 and safety valve 13. Accordingly, the correctly-assembled liquid container 2 can be used at all times.

The present invention is not limited to the above exemplary embodiments, and various modifications can be made within the scope of the present invention. For example, there has been described the case which is screwed into the cover to be removably integrated, the present invention, however, is not limited thereto and the case can be removably integrated into the cover by fitting into or engaging with the part.

What is claimed is:

1. A lifting pipe for a pump-type liquid container comprising:
a draw-up pipe for drawing a liquid within a liquid container main body;
a pouring pipe for communicating between said draw-up pipe and an exterior; and
a safety valve mechanism for stanching said liquid when said liquid container main body is overturned, said safety valve mechanism comprising a case main body and a valve retainer having a safety valve, said case main body being decomposable and communicating between said draw-up pipe and said pouring pipe, and said valve retainer being removably fitted within said case main body.

2. The lifting pipe of claim 1, wherein said safety valve mechanism lies below a mouth portion of said liquid container main body and at least a part of said case main body is placed at a location external to an inner wall of said mouth portion.

3. The lifting pipe of claim 1, wherein said safety valve mechanism comprises a wrong assembly proofing structure for preventing said safety valve and said valve retainer from being wrongly assembled to each other.

4. The lifting pipe of claim 2, wherein said safety valve mechanism comprises a wrong assembly proofing structure for preventing said safety valve and said valve retainer from being wrongly assembled to each other.

5. The lifting pipe of claim 1, wherein said safety valve is supported in said valve retainer under its own weight.

6. The lifting pipe of claim 1, wherein said case main body comprises a case including a trunk portion and a bottom portion connected to said draw-up pipe, and a cover connected to said pouring pipe.

7. The lifting pipe of claim 6, wherein said bottom portion of said case forms a through-hole in the center thereof and comprises a tapered surface inclined toward said through-hole and a bearing surface disposed around the periphery of said tapered surface.

8. The lifting pipe of claim 6, wherein said cover comprises a disk-shaped cover portion for sealing an upper opening of said case and a cylindrical connection having an external thread for screwing into said case, and in the center of said cover portion, an opening is formed to provide said draw-up pipe.

9. The lifting pipe of claim 8, wherein a gasket is disposed in a proximal edge of said connection.

10. The lifting pipe of claim 1, wherein said valve retainer comprises a ring support portion, a receiving portion for holding said safety valve, and connecting rods for connecting said ring support portion to said receiving portion.

11. The lifting pipe of claim 1, wherein said ring support portion is integrated with said receiving portion by said connecting rods to form through-holes between said support portion and said receiving portion.

12. The lifting pipe of claim 10, wherein one or more grooves for liquid passage are provided at an upper end of said receiving portion.

13. The lifting pipe of claim 12, wherein said groove is a concave groove curved away from an upper end of said receiving portion.

14. The lifting pipe of claim 1, wherein said draw-up pipe is arranged concentrically with said pouring pipe.
